(19) United States
(12) Patent Application Publication
(10) Pub. No.: US 2018/0156188 A1
(43) Pub. Date: Jun. 7, 2018

(54) HIGH-EFFICIENCY ECOLOGICAL POWER UNIT

(71) Applicant: Gilbert Ly, Quetigny (FR)

(72) Inventor: Gilbert Ly, Quetigny (FR)

(21) Appl. No.: 15/730,207

(22) Filed: Oct. 11, 2017

Related U.S. Application Data
(63) Continuation-in-part of application No. 13/518,467, filed on Jul. 30, 2012, now abandoned.

(30) Foreign Application Priority Data
Dec. 31, 2009 (FR) 09/06424

(51) Int. Cl. F03B 17/00; F01D 1/06; F01D 1/14; F03B 3/02; F03B 3/10; F03B 3/12

(52) U.S. Cl. CPC F03B 17/005; F01D 1/06; F03B 3/125; F03B 3/02; F03B 3/106; F01D 1/14

(57) ABSTRACT

A power unit including an enclosed housing, a shaft passing through the central section of the enclosed, a motor located outside the housing and mounted to the first end of the shaft, a turbine located inside the housing and mounted into the shaft, the turbine includes a hub, a top end, a bottom end, and blades, sealing fins located at the bottom end of the turbine; and a pump located inside the housing and mounted on the turbine. The pump includes fins that are inserted in grooves located on the hub of the turbine. The fins of the pump are joined to the blades of the turbine creating that the pump, turbine, and shaft move as unitary unit. The fins of the pump maintained by two spaced crowns by insertion form cells that guide a flow of fluid. A space free of fluid with a defined volume occupies the bottom end of the pump. In a non-working position, the space free of fluid has a cylindrical shape. In a working position, because of rotation of the fluid, the space free of fluid has a paraboloid shape. The rotation of the fluid at a minimum angular velocity creates a virtual barrier, and generates a thrust.

### RELATED U.S. APPLICATION

This application is a continuation-in-part of U.S. application Ser. No. 13/518,467 filed Jul. 30, 2012, entitled, HIGH-EFFICIENCY POWER UNIT INDEPENDENT OF THE OUTSIDE ENVIRONMENT, pending, the content of which is incorporated herein by reference, which is a US National Stage Entry of PCT/IB2010/003391 filed Dec. 29, 2010, under the International Convention, which claimed priority over French Patent Application No. 09/06424 filed Dec. 31, 2009.

### FIELD OF THE INVENTION

The present invention relates to an ecological propulsion device that enables attainment of an optimum thrust with high precision.

### BACKGROUND OF THE INVENTION

The action of stirring tea in a cup or moving a glass containing any liquid by holding it firmly and describing a circular motion prompting the liquid to swirl and form a dip in the center of the container. In the event that there is no lid, the faster the circular motion goes, the more the liquid will be forced to spill over . . . By observing this phenomenon, the inventor thought of the idea on how to contain the liquid and at the same time utilize the centrifugal force directly for propulsion instead of a rotating device. The answer was to create a “virtual barrier” that would be capable to hold the liquid creating a thrust.

This led the present inventor to design a closed-circuit system where a fluid contained in a sealed housing would be brought into a rotational motion and swirl while the container will remain immobile.

After a careful review of the diverse types of turbines, the present inventor decided to select the Francis turbine, in contrast to other types of turbines. The Francis turbine operates optimally when it is completely filled with water at all times. Furthermore, Francis turbines can be designed individually to suit a wide range of water heads and flow rates.

In general, the Francis turbine prompts two effects: a motion of rotation (w) coupled with a torque (C), and an axial thrust that results from the ejection of the fluid outwards in accordance with the principle of action and reaction.

In the case of a Francis turbine that is part of a power generation system 20 unit of the present invention, it should be however noted that the axial thrust is not being used since the turbine-generator assembly is fixed. Only the torque is being used to drive the generator.

### SUMMARY OF THE INVENTION

A power unit including an enclosed housing, a shaft passing through the central section of the enclosed, a motor located outside the housing and mounted to the first end of the shaft, a special Francis type reaction turbine located inside the housing and mounted into the shaft, the turbine includes a hub, a top end, a bottom end, and blades, sealing fins located at the bottom end of the turbine; and a pump located inside the housing and mounted on the turbine. The pump includes fins that are inserted in grooves located on the hub of the turbine. The fins of the pump are joined to the blades of the turbine creating that the pump, turbine, and shaft move as unitary unit. Two spaced crowns maintaining the fins of the pump by insertion, form cells that guide a flow of fluid; and

a space free of fluid with a defined volume occupies the bottom end of the pump, a cylinder shape in a non-working vertical position. Such a defined volume is provided so that the fluid can flow freely under the centrifugal force creating a virtual barrier and generating a thrust in the closed circuit at a certain angular velocity.

### BRIEF DESCRIPTION OF THE DRAWINGS

FIG. 1 shows a cross sectional view of the power unit according to the present invention;

FIG. 2 shows a perspective front view of the turbine runner blade (1′) linked with the pump fin (2′) according to an embodiment of the present invention;

FIG. 3 shows a perspective front view of the turbine runner blade (1″) according to an embodiment the present invention;

FIG. 4 shows a graph of current lines (13) at the pump inlet according to the present invention;

FIG. 5 shows a top view of the turbine distributors (12);

FIG. 6a shows a schema showing the free space when the device is at rest;

FIG. 6b shows a schema showing the free space when the motor is turned on at an angular velocity ω<ωₘᵢₙ, a minimum angular velocity;

FIG. 6c shows a schema showing the virtual barrier created at a minimum angular velocity ωₘᵢₙ;

FIGS. 7a-7b show a power unit endowed with a space free of fluid; and

FIG. 7c shows a power unit without a space free of fluid.

### DETAILED DESCRIPTION OF THE INVENTION

In conventional thrusters, two symmetrical forces are created but only one of which is used for propulsion. The other force is useless and therefore ejected into the environment.

To avoid the waste of force, the present inventor thought of the necessity of designing a high-efficiency power unit that uses both symmetrical forces, one of which is for propulsion and the other force is recovered for regeneration due to a virtual barrier. This regeneration is backed by an electric motor. The regenerated force, an action will create a reaction according to the principle of action and reaction, and the cycle recommences.

The power unit comprises, in fact, according to a first feature, a Francis type reaction turbine, but with certain specialties of design and operation. This turbine is axially coupled to a straight radial pump downstream, and upstream to a variable speed electric motor mounted to a common shaft. The pump outlet is communicated to the turbine inlet via a stationary tank. The turbine pump unit forming a closed circuit in an enclosed housing is controlled by this variable speed electric motor which is used to set in motion and to compensate for the loss of hydraulic and mechanical energy.

Unlike the Francis turbine, the turbine of the power unit, centerpiece of the system, powered by a straight radial pump, restores, at the outlet of the wheel, the fluid with a minimal and relative axial velocity, W₂ₜ. It is shown that W₂ₜ is equal to the circumferential velocity, r×ω (r=radius of the turbine, ω=angular velocity in radians/second), thus with a non-axial absolute velocity.

C₂ₜ=W₂ₜ √2 and not negligible. Therefore, usable energy still remains after the passage of the fluid in the wheel. The modulus, the direction of the absolute velocity C₁ₜ, as well as the relative pressure P₁ₜ at the entrance of the wheel, are calculated, on the one hand, to ensure a given flow rate with a corresponding angular velocity and, on the other hand, to overcome the centrifugal force imposed by the rotation of the fluid as we will consider later. The angle α of C₁ₜ remains fixed and is irrespective of the flow.

However, the shape of the channel (runner crown and runner band) is identical to that of the Francis turbine, except that the radius at the inlet is the same as that of the outlet

The blade of the turbine, having the shape of a curved half spoon radially straight at the outlet and adapting the profile of the channel, is curved so as to straighten the velocity vectors at the inlet, C₁ₜ orthogonal to the axis of rotation, 90° and radially straight at the outlet. Thus, at the outlet, these velocity vectors are parallel to the axis of the turbine. The assembly is surrounded by a cylindrical sleeve forming the exterior wall of the runner band. According to the conditions of flow, another variant of blading, approximating that of the Francis turbine, is a trapezoidal plate, twisted and curved so as to ensure the same function of recovery as previously. The number of blades is a function of the specific velocity, and is between eleven and seventeen. At the outlet of the turbine, the blade will be placed side by side to that of the pump inserted in the groove of the turbine hub, thus forming a solid piece for the continuity of fluid flow. Finally in order to best ensure the sealing of the shaft with the exterior environment, the bottom of the turbine is equipped with fins in order to keep the fluid away from the shaft by centrifugation.

The straight radial pump, fed back by the turbine, recuperates the fluid at the outlet of the latter with a relative velocity, W₁ₚ=W₂ₜ. The relative velocity at the outlet of the pump is also axial, having modulus W₂ₚ=R×ω shown by calculation. (R=exterior radius of the pump).

The fin of the pump is a plate having a radially straight L-shape, extension of the blade of the turbine. The fins are maintained and reinforced by two spaced profiled crowns forming cells that guide the flow of the fluid. To better convey the fluid, these cells adapt to the boundaries of the lines of current. From the outlet side of the turbine, its configuration is a truncated cone with exponential curvature, and from the opposite side it is a truncated straight cone whose generatrix is tangential to the current lines that we will see later in the mathematical study of the flow.

A space free of fluid with a defined volume is formed between the bottom end of the pump and the hub, and has a shape of a cylinder in a non-working vertical position. The features of this space free of fluid will be detailed later during operation.

A cooling system located in the free space at the top end of the housing comprises two ports, whose opening is controlled by two solenoid valves. The cooling circuit operates in case of overheating of the turbine pump unit or pressure adjustment. In the zone where the centrifuged fluid exists during operation, there is a pressure adjustment port connected to the pressure gauge for measuring the static pressure of the centrifuged fluid at a given point, and one deduces from it, the volume of free space in order to regulate it by adding or removing the necessary volume of the centrifuged fluid. The width of the crown of the centrifuged fluid determines the relative pressure, P₁ₜ at the inlet to the turbine as shown later by fluid dynamics.

To avoid overlap between the threads of current at the inlet of the pump, the radius of the hub must be equal or greater than 37% of that of the turbine. At the outlet of the pump, the fluid having acquired its maximum energy passes axially through a stationary tank. A spacer part of the tank, at the corner between the pump and turbine, is used to guide the flow of fluid to the inlet of the latter in order to resupply it. The outlet of the pump limited by the exterior diameter of this spacer forms a ring whose thickness determines the rate of flow. In operation, there is thus energy exchange between the turbine and the pump.

As the velocities are uniformly distributed on concentric circles at the outlet of the pump, the fluid will be channeled in a circular, non spiral tank as the case of the Francis turbine. We have already seen that from the relative axial velocity at the outlet of the pump, W₂ₚ=R×ω, it follows that its absolute velocity, C₂ₚ=√2. W₂ₚ, deviates from 45° with respect to the direction of the axis, and in the direction of rotation. The tank having the form of a bowl with flat bottom constitutes, with the spacer, a channel that directs the fluid to the turbine via the distributors. The profile of the distributor is that of an elongated bead of least hydrodynamic resistance. We recall that the mean line of the distributor forms an angle α of C₁ₜ.

At the ends of the common shaft of the turbine pump unit, axial stops are mounted in tandem with sealed bearings for supporting the thrust generated by the power unit. The assembly of the turbine pump tank unit is enveloped by a cylindrical structure that forms a closed chamber, allowing traversal of the common shaft coupled to a drive motor.

The materials used in the manufacture of the hydraulic turbo machine and its technology fit perfectly in the implementation of the power unit.

Finally the variable speed drive motor with frequency modulation enables the setting in motion, the maintenance of rotation during the exchange of energy between the pump and the turbine, and the control of the thrust with great precision.

### Science Behind It

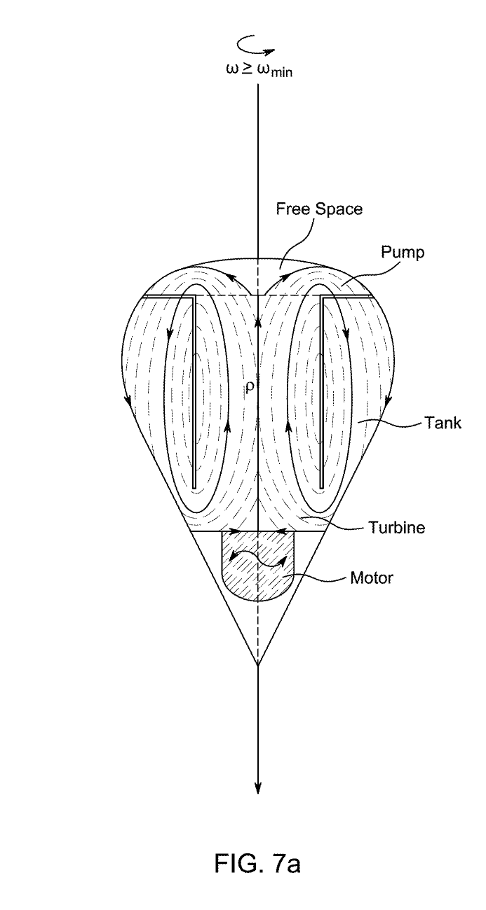

Now let's begin the operation. Before starting, the free surface of the fluid under the space free of fluid as well as the surfaces at constant pressure P₀, P₁, P₂ . . . (isobar) remains horizontal since it is subjected to the sole action of gravity (See FIG. 6a.)

When the motor is turned on, both the pump and the turbine start revolving together with the fluid. The turbine being filled with motionless fluid and setting in motion by the motor plays the same role as a centrifugal pump generating the velocity and the pressure of the fluid. As the isobar surfaces stretch out, the fluid flows from the turbine to the outlet of the pump. The entire system therefore functions as a centrifugal pump in a closed cylinder with a radius R at an angular velocity ω.

Fluid mechanics has shown that in a vertical closed cylindrical container with radius R partially filled with a liquid and rotated about its axis OX at a constant angular velocity ω, the equation for the surfaces of constant pressure (isobar) including the free surface are the paraboloids of revolution determined by the parabolas of equation X=[(R²×ω²)/2g]+constant, g being the acceleration of gravity. The shape of these parabolas depends on ω² only as their parameter is equal to g/ω². Therefore, the pressure of the isobar surfaces P_{R} is [p(R²×ω²)/2]+constant which depends on R² and ω².

By transposing to the power unit, when the motor is turned on, the cylinder becomes a paraboloid the shape of which depends only on ω². The center O of the free space dips into S₀ when the edge B reaches the top A (FIG. 6b). if ω increases, the paraboloid shrinks, and the width L of the centrifuged fluid crown around the free space at the bottom of the pump becomes larger because the volume of the free space is constant. To enable the fluid flow from the pump outlet to the turbine, the pressure of the former must overcome that of the latter inlet with a minimum angular velocity ωₘᵢₙ. Let r be the radius of the turbine, r₀ the radius of the hub, R the radius of the pump, R₀ the radius of the free space at the bottom of the pump, Rⱼ the radius of paraboloid in which the pressure of the centrifuged fluid is equal to that of the top i of the turbine inlet, L the width of the centrifuged fluid crown, E the width of the pump outlet. We have R=R₀+L=Rⱼ+E (FIG. 6).This yields

ρωₘᵢₙ²(Rⱼ²−R₀²)/2≥ρωₘᵢₙ²(r²−r₀²)/2⇒Rⱼ²−(r²−r₀²). ≥R₀² (1)

On the isobar surface in the fluid, we have: X_{Rj}−Xᵣ=(Rⱼ²×ωₘᵢₙ²)/2g−(r²×ωₘᵢₙ²)/2g=h, given from the drawing, X_{Rj}, Xᵣ being the heights of the paraboloid with radius Rᵢ and r. We have:

X_{Rj}−Xᵣ=(Rⱼ²×ωₘᵢₙ²)/2g−(r²×ωₘᵢₙ²)/2g=h (2)

Thus:

ωₘᵢₙ²=(h×2g)/(Rⱼ²−r²) or ωₘᵢₙ=[(h×2g)/(Rⱼ²−r²)]^{1/}₂

The equations (1) and (2) give the value of R₀ and ωₘᵢₙ. As the equation of the parabolas for isobar surfaces is X=[(R²×ω²)/2g]+constant, (2) states that this constant is zero. The above parameters (R₀, ωₘᵢₙ) enable us to determine the graphs of the isobar surface at ωₘᵢₙ and in particular that of the free surface MNSO₀PQ, thus its volume. It is shown that this volume is equal to half that of the cylinder MM′Q′Q (See FIG. 6c). The net volume of the space free of fluid is MNN′BCP′PQ after deduction of that of the emerged matter and the centrifuged fluid. Note that if ω increases, L widens and R₀ decreases. The pressure at the pump outlet increases with ω² and L, whereas the pressure created by the centrifugal force of the fluid in the turbine increases with ω² only. Since there is a stream reversal at ωₘᵢₙ, it is necessary to keep this speed hanging in a period of time before incrementing to avoid turbulence flowing. Under zero gravity or at very high speed, the paraboloid tends towards a cylinder.

Now let's study the free space in the flowing fluid. The working fluid coming from the pump enters into the turbine through the stationary tank with a maximum absolute velocity C₁ₜ under a relative pressure P₁ₜ. During the time ΔT, it turns the turbine at angular velocity ω≥ωₘᵢₙ with a torque C and comes up to the outlet with a minimum relative axial velocity W₂ₜ under the pressure P₂ₜ equal to the atmospheric pressure P₀. In this closed-circuit, the working fluid at the turbine outlet shall be returned to its initial state C₁ₜ, P₁ₜ at the inlet by means of the generated power Cω provided to the pump and backed by an electric motor during the time ΔT, as these three components are mounted together on a common shaft. It is shown that relative minimal axial velocity W₂ₜ=r×ω.

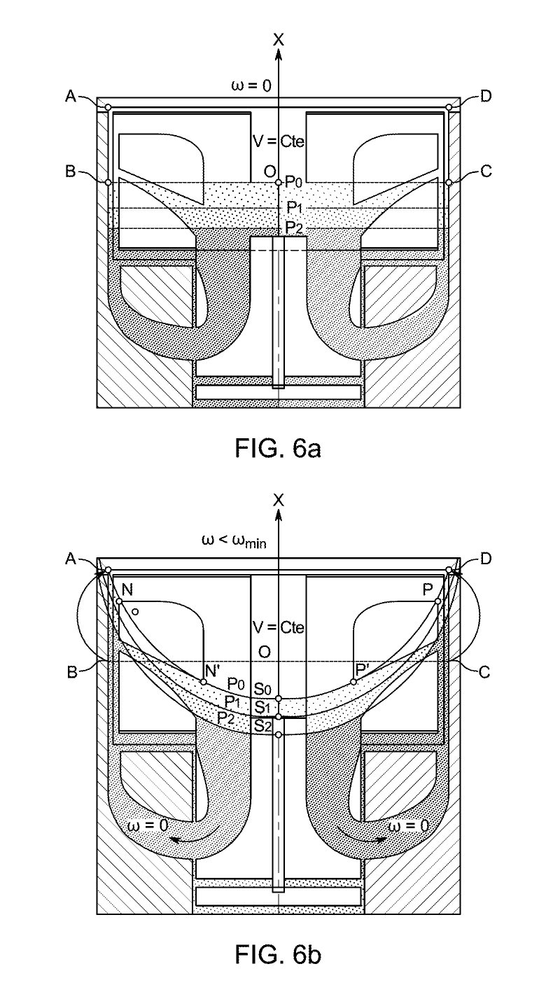

Consider a reference XOY linked to the turbine, OX being carried by the axis of rotation, and OY by its outlet base, which represents the radius r of the turbine (FIG. 4).

We have W₂ₜ=r×ω=Y×ω=W₁ₚ

At the inlet of the pump, the element of fluid mass dm is subjected to the centrifugal force f=dm×rω²=dm×Y·ω². Yet f=dm×γ=dm×Y″(t); thus

Y″(t)=Y(t)×ω²

By integrating this differential equation, we obtain:

Y=Y₀·exp ωt (3)

On the OX axis, we have X=W₁ₚ×t=Y₀×ωt, or X/Y₀=ωt

By replacing ωt with X/Y₀ in (3), we obtain: Y=Y₀·exp X/Y₀

These current lines are thus independent of ω and depend only on Y₀. It is shown that they are tangential to the line Y=eX (e=2.7182 . . .) which is fixed. In other words, whatever its velocity, the fluid ejected from the turbine will not pass through the line Y=eX, but it is diverted to the exterior of the free space. This line is somehow a virtual barrier. The free space is limited by a volume of revolution determined by this tangent and a section of parabola of equation X=(r²×ω²)/2g as mentioned above. Similarly, for the net volume of the free space in the fluid flowing zone, we have to take into account the volume of the emerged matter. The turbine-pump assembly must therefore be partially filled with centrifuged fluid.

Let us now see the thrust generated by the power unit. For reasons of symmetry, the forces exerted by the moving fluid on the walls outside of the axial free space zone cancel out. Only remaining is the thrust exerted on the turbine in the axial zone opposite the free space. Let us first calculate the maximum flow rate Q (with the radius of the hub r₀=0 and neglecting the section of the blade relative to that of the turbine).

We know that at the outlet, we have a linear distribution of velocities: V=r×ω.

dQ=V·ds with ds=2πr·dr

We thus have: Q=∫₀^{r}V·ds=∫₀^{r}rω·2πr·dr=(⅔)πωr³

And the mass flow rate q=ρ×Q=(⅔)ρπωr³, ρ being the density of the fluid. According to the principle of linear momentum, by being ejecting from the turbine, the fluid exerts on the latter a dynamic thrust P such that:

P=∫₀^{r}V·ρdQ=ρ∫₀^{r}r²ω²2πr·dr=(½)ρπω²r⁴

This formula shows that this thrust would be the same as if the circuit were open. Yet the circuit is closed by said virtual barrier which does not affect the thrust whatever the pressure and velocity of the upstream fluid be. Therefore in the conventional thruster, the virtual barrier is rejected to infinity. Moreover, as the acceleration of the gravity is negligible before the centrifugal acceleration of the turbine, the behavior of the current lines as well as the shape of the free space remains practically unchanged during the orientation of the power unit as needed. In addition to its large useful load bearing capacity [(½)ρπω²r⁴], this power unit assures optimal safety for priceless human lives, due to its flexibility and workability.

To improve the performance of the power unit, one can reduce the frictional forces by covering the surfaces that contact the fluid flow with a layer of PTFE (TEFLON), and uses as centrifuged fluid the CCl₄. Note that the presence of the hub radius r₀ (nonzero)=37% of r, radius of the turbine provided above, does not practically change the intensity of the thrust P, because [(½)ρπω²(37%·r)⁴] is negligible before [(½)ρπω²r⁴]. Finally the drive motor with variable speed frequency modulation allows the thrust control at will with great accuracy. One can use the power unit throughout space to equip the flying vehicles, even those with vertical takeoff. For example, the power unit whose radius of the turbine, r=10 cm, rotating at 3000 rev/min, and using water as centrifuged fluid, generates a thrust P approximately 1550 kg. This thrust is sufficient to vertically levitate a flying vehicle of more than one ton.

It is important to emphasize that, the power unit according to the present invention creates a force, an entity quite different from energy. Basically, a force can be canceled, whereas energy is a conservative quantity e.i. it cannot be annihilated. The force generated by the power unit is canceled in case of hover or when the power unit is no longer backed by the electric motor, but its kinetic energy cannot be annihilated and ultimately will be turned into heat due to friction. Confusing energy with force leads to the violation of the relevant laws. Furthermore, though its novelty regarding the closed circuit, said invention is based on nothing but the laws of classical mechanics used by the persons skilled in the art since several centuries.

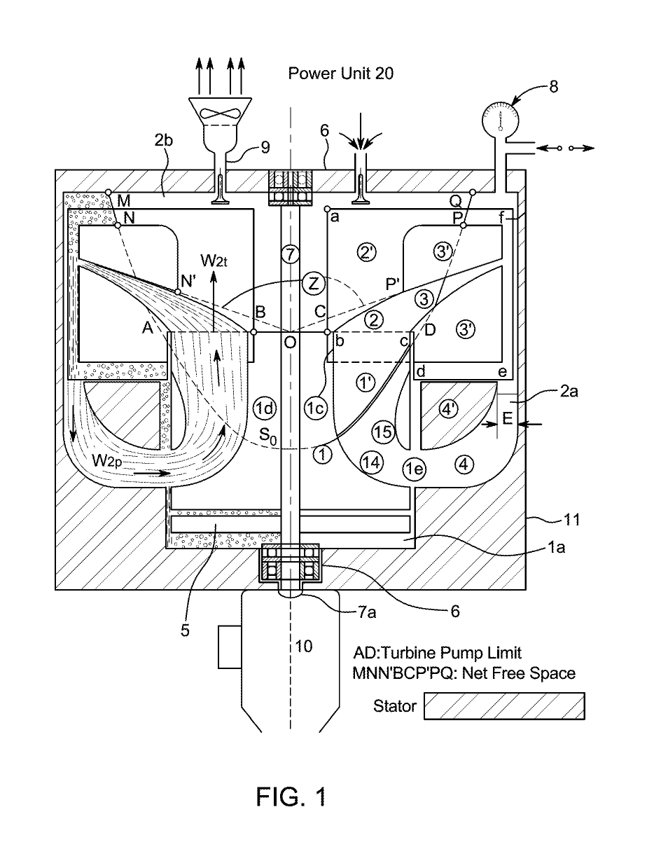

In reference to the drawings, FIG. 1 shows that the turbine 1 of the present invention works upside down compared to the vertical Francis turbine for a standard power generation. The power unit 20 includes an enclosed closed housing 11. The enclosed housing 11 is a sealed housing.

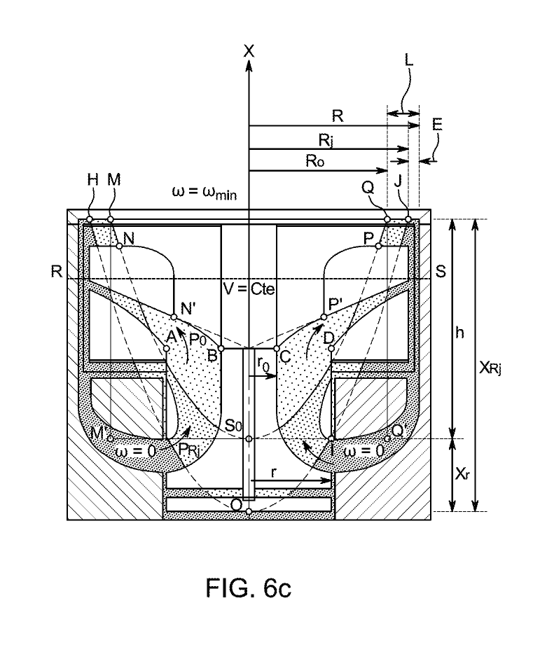

A turbine 1 is located inside the housing 11. The turbine is mounted into a shaft 7. The shaft 7 passes through a central section of the housing 11. The shaft 7 has a first end 7a protruding from the housing 11. The shape of the channel of the turbine runner crown 14 and runner band 15 is the same as that of the Francis turbine, except that the radius at the inlet is the same as that of the outlet. The turbine 1 includes blades 1′ to rectify the velocity vectors at the entrance C₁ₜ (FIG. 5) orthogonal to the axis of rotation, 90° and radially straight to the outlet with an axial minimum relative velocity, equal to the circumferential velocity, r×ω (r being the radius of the turbine, ω the angular velocity).

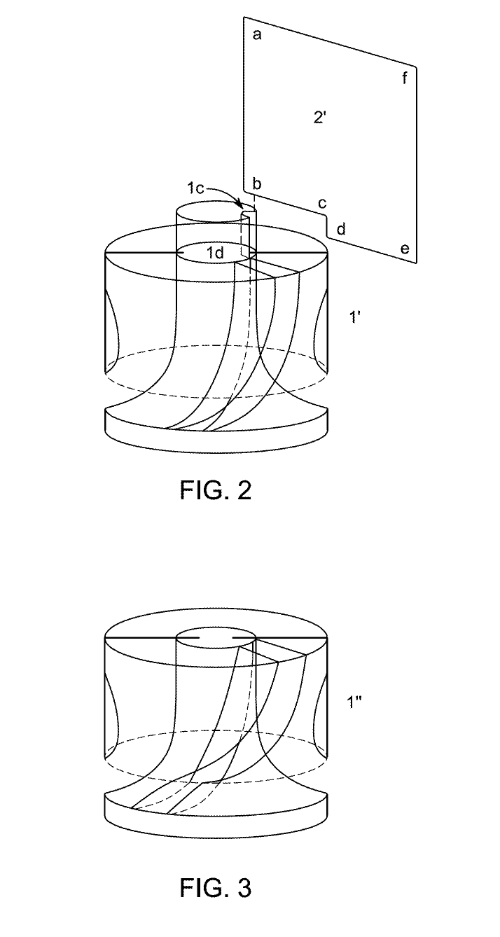

In one embodiment shown in FIG. 2, the shape of the blades 1′ is a curved half-spoon so that the relative velocity vectors at the outlet W₂ₜ are axially straight. The curved shape helps to straighten the velocity vectors at the inlet, C₁ₜ orthogonal to the axis of rotation, 90° and radially straight at the outlet. Thus, at the outlet, these relative velocity vectors are parallel to the axis of the turbine.

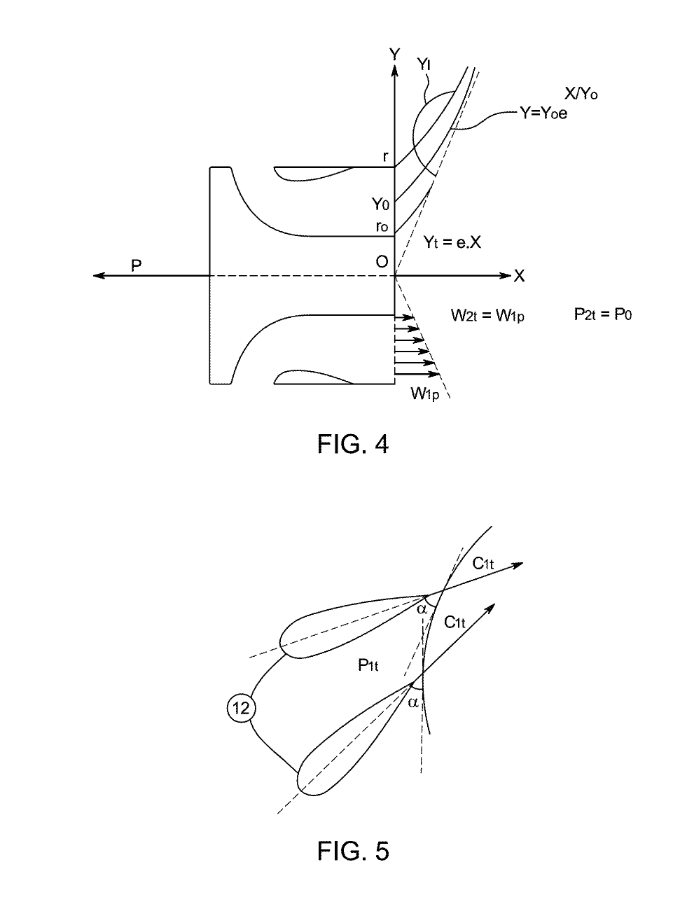

In another embodiment, the blades 1″ have a shape of a trapezoidal plate (FIG. 3), twisted and curved to ensure the same recovery function.

The number of blades 1′ or 1″ is a function of the specific velocity, and is between eleven and seventeen. At the outlet of the turbine, the blade will be placed side by side to that of the pump, thus forming a solid piece for the continuity of fluid flow.

In addition, the bottom 1a of the turbine 1 is equipped with sealing fins 5 in order to separate the fluid from the shaft 7 by centrifugation, which provides a more effective sealing from the external environment.

A motor 10 is located outside the housing 11 and mounted to the first end 7a of the shaft 7 by using a bearing assembly 6. The motor 10 may be a variable speed and frequency modulation motor. The motor 10 controls the thrust of the power unit 20 with high accuracy and keeps the motion.

A pump 2 is located inside the housing 11. The pump 2 may be a straight radial pump. The pump is mounted on the turbine 1.

The pump 2 includes fins 2′ that are inserted in the grooves 1c on the turbine hub 1d; thus, the fins 2′ of the pump 2 are joined to the blades 1′ of the turbine 1 (FIG. 1-2). In view of this, the turbine 1, the pump 2, and the shaft 7 move as unitary unit creating a continuous flow.

The pump outlet 2a is connected to the turbine inlet 1e via a stationary tank 4.

The fins 2′ of the pump 2 are maintained and reinforced by two spaced streamlined crowns 3′ forming cells 3 that guide the fluid flow. To better convey the fluid, these cells 3 match the boundaries of the current lines Yi, which are fixed, regardless of the speed of rotation. (FIGS. 1 and 4). From the outlet side of the turbine, the configuration of the streamlined crown is a truncated cone with exponential curvature, and from the opposite side it is a truncated straight cone whose generatrix is tangential to the current lines shown by mathematical study of the flow.

The fin 2′ of the pump 2 connected to the blades 1′ of the turbine 1 forms a L-shape abcdef (FIG. 1-2) in order to satisfy the flow conditions.

The flow rate depends on the width E of outlet 2a of the pump 2. The tank 4 lined with a spacer 4′, having the shape of a bowl with a flat bottom, is compartmentalized by distributors 12 whose center line forms an angle α of C₁ₜ (FIGS. 1 and 5). The profile of the distributor is that of an elongated bead having the least hydrodynamic resistance.

The relative velocity at the outlet of the pump W₂ₚ is shown as equal to the circumferential velocity R×ω (R being the radius of the pump) and its absolute velocity is therefore W₂ₚ√/2. The working fluid will then be directed to the inlet of the turbine 1e under a pressure P₁ₜ via the distributors 12 in FIG. 5 contained in the tank 4.

As regards to the operation, the analysis of the functioning has shown that the power unit requires a minimum angular velocity creating sufficient pressure in the pump to trigger the thruster (FIG. 6a-6c).

The working fluid is under a relative pressure P₁ₜ (FIG. 5) determined by the width L of the centrifuged fluid (FIG. 6c). At the outlet of the turbine, the working fluid is collected in a free space.

FIG. 6a shows the free space ABOCD of the power unit at rest with a defined volume V, a cylinder surrounded by the wall of the enclosed housing, located at the bottom end of the pump.

FIG. 6b shows that when the motor is turned on (working position), the cylinder becomes a paraboloid the shape of which depends only on ω². The center O of the free space dips into S₀ when the edge B reaches the top A, The fluid flows from the turbine to the pump. If ω increases, the parabola shrinks, and the free space is surrounded by a crown of centrifuged fluid at the bottom 2b of the pump where the pressure augments rapidly.

FIG. 6c shows that when the angular velocity ω≥ωₘᵢₙ, the pressure at the pump outlet overcomes that of the turbine, and the fluid flows from the pump to the turbine. The volume of the free space due to rotation will be shared by the one generated by a virtual barrier Z. The virtual barrier Z is fixed and independent of ω. As the free space comprises a rotation zone and flowing zone (FIG. 6c), the users don't have to care about the orientation of the pump or the power unit after the power unit reaches a proper angular velocity.

To avoid overlap between the threads of current at the inlet of the pump, the radius of the hub must not be less than 37% of that of the turbine. At the outlet of the pump, the fluid having acquired its maximum velocity passes axially through a stationary tank. A spacer part of the tank, at the corner between the pump and turbine, is used to guide the flow of fluid to the inlet of the latter in order to resupply it. The outlet of the pump limited by the external diameter of this spacer forms a ring, the width of which determines the rate of flow.

The bottom 2b of the pump 2 comprises two instruments: a cooling system 9 and a pressure adjustment device 8. The cooling system communicated with the free space and is equipped with two ports whose opening is controlled by two solenoid valves that operate only in case of overheating of the closed circuit turbine-pump assembly or pressure adjustment. The pressure adjustment device endowed with a pressure gauge is used to regulate the relative pressure P₁ₜ at the inlet of the turbine by removing or adding the centrifuged fluid according to the measure of the static pressure at a specific point J on the width (L) of the crown of the centrifuged fluid, which determines the relative pressure at the turbine inlet.

FIG. 6c shows a detailed view of the free space when the angular velocity of the motor reaches a minimum value ωₘᵢₙ. MNS₀PQ represents the graph of the free surface where the pressure is equal to the atmospheric pressure, the net free space MNN′BCPP′Q. HOiJ represents the isobar surface where the pressure is equal to that of the top i of the turbine inlet at a minimum angular velocity ωₘᵢₙ to activate the thruster. We can distinguish the fluid rotation zone flow from the fluid flowing zone (helical motion) separated by the line RS.

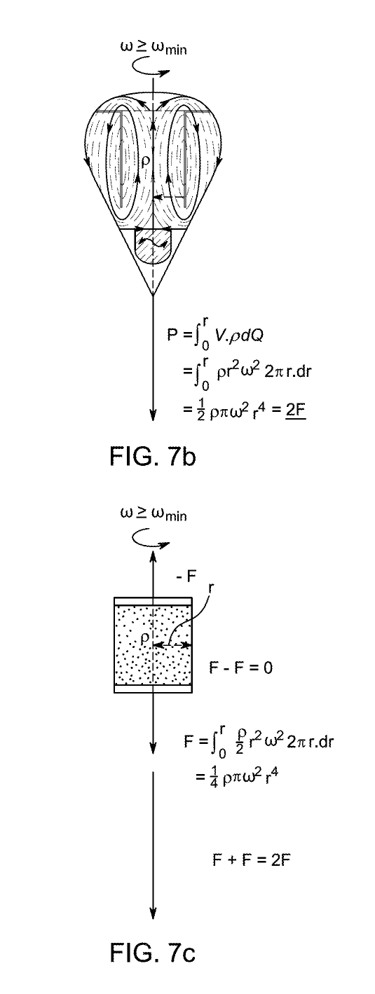

The above lines show the importance of the space free of fluid. As a matter of fact, without space free of fluid (See FIG. 7c), the barrier is actual (the top of the pump) in a closed circuit. For reason of symmetry, the forces exerted by the moving fluid cancel out. Therefore, the space free of fluid enables the fluid to flow freely creating a virtual barrier.

The thrust of the power unit—For reasons of symmetry, the forces exerted by the moving fluid on the walls outside the axial free space zone cancel out. By ejecting from the turbine, according to the principle of linear momentum, it was found that the fluid exerts a dynamic thrust P=(½)ρπω²r⁴ (neglecting r₀, the radius of the hub of the turbine, and the section of the blade relative to that of the turbine) in FIG. 4. In the case where the radius of the hub of the turbine, r₀=37% of r, radius of the turbine cited above, the calculation shows that the new thrust P′=98% of P. Finally, to improve the performance of the power unit, the contact surfaces with the fluid flow will be covered with a layer of PTFE (TEFLON) to reduce friction and the CCl₄ is used as centrifuged fluid.

The power unit 20 is designed to propel an object ecologically without rejection of any matter which is not necessary and more importantly it can operate anywhere in the environment (in the air, underwater, on the surface, in empty space).

In summary, the power unit 20 includes a Francis turbine 1 in which:
1. The blade (1′) rectifies the velocity vectors at the entrance, C₁ₜ (FIG. 5) orthogonal to the axis of rotation, 90° and radially straight to the outlet with an axial minimum relative velocity, equal to the circumferential velocity, r×ω. At the outlet of the turbine, the fluid is collected in a free space, MADQ (MNN′BCP′PQ being the net free space) by a straight radial pump 2, the fin 2′ forms a part united with the turbine blade 1′ for continuity of flow.
2. The fins 2′ are maintained and reinforced by 2 spaced streamlined crowns 3′ forming cells 3 that guide the fluid flow. To ensure a better direction of the fluid, these cells 3 match the boundaries of the current lines Yi 13 in FIG. 4, which are fixed, regardless of the angular velocity.
3. The relative velocity at the outlet of the pump W₂ₚ is also axial and equal to the circumferential velocity, R×ω (R being the radius of the pump). The fluid will then be directed to the inlet of the turbine via the distributors 12 contained in a stationary tank 4.
4. The turbine 1 will thus be powered for operating the pump assisted by the electric motor.

When the motor 10 is turned on, both the pump 2 and turbine 1 start revolving as they are axially coupled together. Under the action of the centrifugal force, the center of the free surface of the fluid starts dipping and the turbine plays the role as a centrifugal pump until a minimum angular velocity above which the fluid flows from the pump to the turbine (FIG. 6c).

Always under the centrifugal force, the lines of current at the turbine outlet are independent of ω and tangential to the a fixed line Yₜ=eX(e=2.7182 . . .). This tangent plays the role of a “virtual barrier” that prevents the centrifuged fluid, discharged by the turbine, from reaching the bottom of the pump in the free space zone [actually this “bottom” is the top of the pump in the particular case of our invention], and simultaneously keeps intact the force exerted on the turbine (thrust) resulting from the ejection of the fluid outward (FIG. 4).

Furthermore, it directs the fluid towards the outlet of the pump to resupply the turbine.

The pump 2 representing the water head feeds the turbine 1, which develops a power necessary to return the working fluid to its initial state in its inlet from its outlet one, and assisted by the electric motor of course.

Under the action of the centrifugal force, the center of the free surface starts to dip and the fluid rises along the wall of the housing cylinder forming a crown of centrifuged fluid. The higher the rotational speed, the larger the width of the centrifuged fluid crown, so is the pressure at the pump outlet. Ultimately, when the latter is greater than that of the turbine inlet, the fluid flows from the pump into the turbine with a defined velocity and pressure. This is the beginning of the cycle.

By passing through the turbine, the working fluid creates a motion of rotation (ω) coupled with a torque (C) and an axial thrust that results from the ejection of the fluid outwards. Under the action of the centrifugal force, the limit of current lines at the pump inlet forms a fixed “virtual barrier”, which prevents the centrifuged fluid from reaching the “bottom” of the pump in the free space area. In fact, this “bottom” refers to the actual “ceiling” i.e. top of the pump of our power unit. Moreover, the torque (C) developed in the turbine with a rotation (ω) permits the working fluid at the inlet of the pump to recover its initial state in the outlet backed by the electric motor.

Looking at the axial forces: the first force being the force that ejects the fluid from the turbine towards the “bottom” of the pump and the second force is the one that results from the ejection of the fluid outwards in accordance with the principle of action and reaction. However the first force is bent tangentially to the virtual barrier and continues along its path away from the free space. Therefore, the ejected fluid will not reach the “bottom” of the pump in the free space zone. So remains the second exerting on the turbine (thrust).

For reasons of symmetry, the forces exerted by the moving fluid on the walls outside of the axial free space area cancel out. Eventually, the thrust exerted by the moving fluid on the turbine in the axial zone opposite the free space remains.

What is claimed is:

1. A power unit comprising:
an enclosed housing including a top end, a bottom end, a central section with internal space;
a shaft passing through the central section of the enclosed housing and having a first end protruding from the top end of the housing;
a motor located outside the housing and mounted to the first end of the shaft;
a turbine located inside the housing and mounted into the shaft, the turbine includes a hub, a top end, a bottom end, and blades;
sealing fins located at the bottom end of the turbine;
a pump located inside the housing and mounted on the turbine, the pump includes fins that are inserted in grooves located on the hub of the turbine, the fins of the pump are joined to the blades of the turbine creating that the pump, turbine, and shaft move as unitary unit;
two spaced crowns located at the turbine outlet maintain the fins of the pump by insertion, the spaced crowns form cells that guide a flow of fluid while adapting a limit of current lines; and
a space free of fluid located between the bottom end of the pump and the hub with a defined volume occupying the bottom end of the pump surrounded by the wall of the enclosed housing in a non-working vertical position, defined volume corresponds to a width of a centrifuged fluid at the bottom of the pump at a minimum angular velocity where a minimum relative pressure at the inlet of the turbine P₁ₜ is equal to a pressure created by the centrifugal force at that point;
a cooling system located at the free space at the top end of the housing with two ports, whose opening is controlled by two solenoid valves;
a pressure adjustment port by removing or adding the centrifuged fluid during operation, the pressure adjustment port is connected to the pressure gauge.
wherein in a non-working vertical position the space free of fluid has a cylindrical shape in the enclosed housing;
wherein in a working position, because of rotation of the fluid, the space free of fluid has a paraboloid shape; and
wherein the rotation of the fluid at a minimum angular velocity that creates a virtual barrier at the space free of fluid generating a flowing fluid from the pump to the turbine.

2. The power unit according to claim 1, wherein a pump outlet is connected to a turbine inlet via a stationary tank compartmentalized by distributors.

3. The power unit according to claim 1, wherein the blades of the turbine have a curved shape.

4. The power unit according to claim 1, wherein the blades of the turbine have a shape of a trapezoidal plate, twisted, and curved.

5. The power unit according to claim 1, wherein the pump is a straight radial pump.

6. The power unit according to claim 1, wherein a radius of the pump is greater than a radius of the turbine in such a way that at a minimum angular velocity of the power unit, the minimum pressure at the inlet of the turbine is equal to that created by the centrifugal force at that point.

7. The power unit according to claim 1, wherein the fin of the pump connected to the blades of the turbine has a shape of a L.

8. The power unit according to claim 1, wherein the turbine is a Francis turbine having a radius at the inlet that is equal to a radius at the outlet, and a radius of the hub is equal or greater than 37% of a radius of the turbine.
